(19) United States
(12) Patent Application Publication
(10) Pub. No.: US 2011/0170592 A1
(43) Pub. Date: Jul. 14, 2011

(54) METHOD FOR EFFICIENTLY ENCODING IMAGE FOR H.264 SVC

(75) Inventors: Je Woo KIM, Gyeonggi-do (KR); Yong Hwan KIM, Gyeonggi-do (KR); Hwa Seon SHIN, Gyeonggi-do (KR)

(73) Assignee: KOREA ELECTRONICS TECHNOLOGY INSTITUTE, Gyeonggi-do (KR)

(21) Appl. No.: 12/979,545

(22) Filed: Dec. 28, 2010

(30) Foreign Application Priority Data
Jan. 13, 2010 (KR) 10-2010-0003031

(51) Int. Cl. H04N 7/26

(52) U.S. Cl. 375/240.03; 375/E07.14

(57) ABSTRACT

An efficient image encoding method for H.264 SVC is provided. When a base layer macroblock mode MODE_{BL} is intra, the image encoding method calculates a I16×16 mode value for a Pred_Mode of I16×16 of the MODE_{BL}, calculates a mode value of the base layer, compares the I16×16 mode value with the mode value of the base layer, and thus selects the best mode. Also, the method calculates a mode value for a skip mode of the base layer, compares the skip mode value with a pre-determined quantization parameter threshold, and thus selects the best mode. Hence, the image coding efficiency can be enhanced by improving complexity in the mode decision in the H.264 SVC encoding process.

### TECHNICAL FIELD OF THE INVENTION

The present invention relates generally to an efficient encoding method for H.264 SVC. More particularly, the present invention relates to an efficient encoding method for reducing complexity in the encoding process for H.264 SVC.

### BACKGROUND OF THE INVENTION

In recent, international standard Scalable Video Coding (SVC), which embraces various SNR scalability, temporal scalability, and spatial scalability in one coded stream, is a scalable video coding technology adoptable to various applications. The SVC technology is based on H.264 video coding standard, employs a layer-based approach and a hierarchical B (or P) structure to support the various SNR scalability, temporal scalability, and spatial scalability.

The layer structure is used to support the SNR scalability and the spatial scalability, and the hierarchical B (or P) structure is used to support the temporal scalability. In particular, for mobile applications requiring low delay and low complexity, a SVC baseline profile providing the hierarchical P structure and the constrained resolution support (support only the resolution down/up-sampling rates 1, 1.5 and 2) is defined.

Since the SVC coding technology includes the H.264 scheme based on Macro Block (MB) unit encoding, intra modes include MODE_I16×16, MODE_I4×4, and MODE_I8×8, and inter modes include MODE_{—}16×16, MODE_{—}16×8, and MODE_{—}8×8. The MODE_{—}8×8 can be divided into MODE_{—}8×4, MODE_{—}4×8, and MODE_{—}4×4 according to an MB sub-partition. As such, together with the various MB modes, I_BL, BL_SKIP and MV_PRED mode of the SVC codec intrinsic techniques are included.

Hence, to generate the SVC video coded stream, a mode decision process for comparing all of the various modes and selecting a best mode in terms of Rate-Distortion Optimization (RDO) is necessary. The mode decision process includes motion estimation and intra prediction.

A Base_Layer (BL) of the SVC, which needs to be compatible with H.264, does not adopt the SVC technology and includes the MB modes of H.264. An Enhancement layer (EL) of the SVC includes I_BL, BL_SKIP and MV_PRED modes which are the MB modes of the SVC, together with the MB modes of the BL.

Determining which mode is used to code the MB is the core of the H.264 encoder. Unlike a conventional video compression coding standard, H.264 takes account of a bit rate together with the distortion so as to determine the best mode among the several modes. For doing so, a cost function based on Lagrangian function is used. The cost function used to determine a motion vector for each block and to determine the best mode of the MB includes terms indicating the distortion and the bit rate, and a Lagrangian multiplier which is a weight value of the bit rate.

FIG. 1 depicts the mode decision using a conventional RDO method. As shown in FIG. 1, after RDcost is calculated for every possible MB mode, the MB mode exhibiting minimum bit and efficiency in terms of the RDO is selected. That is, the BLSKIP mode through the IPCM mode is compared with the MB of the original image and then the mode exhibiting of the best performance is selected as shown in FIG. 1.

In the conventional RDO method of FIG. 1, a differential MB obtained by differentiating the original image and a compensated MB of each MB mode performs integer DCT and quantization. Sum of Absolute Difference (SSD) is determined by comparing the restored MB image with the original image in a pixel domain combining the differential MB restored through Inverse Quantization (IQ) and Inverse DCT (IDCT) and the compensated MB. Thus, to compare the modes, the DCT, the quantization, the IQ, and the IDCT are required. Naturally, in the complexity, the MB mode decision adopting the RDO occupies most of the SVC encoding process.

The H.264 encoding process using the conventional mode decision using the RDO is not suitable for the real-time encoding of the current SVC video encoder because of too much computational complexity in the motion prediction and the mode decision. To compensate this defect, a fast MB mode decision method is demanded.

The H.264 SVC transforms residual data after the mode decision. The H.264 SVC transforms the data by selecting one of two schemes; that is, 4×4 integer DCT transform and 8×8 integer DCT transform.

With respect to the intra MB, when the mode selected in the previous mode decision is I_{—}4×4 or I_{—}16×16, the 4×4 transform is used. In the I_{—}8×8, the 8×8 transform is used. It is general to perform the 4×4 transform and the 8×8 transform on the inter MB and then to utilize the optimum result. Accordingly, the transform is repeated to select the 4×4 transform and the 8×8 transform, which also increases the complexity in the encoding process.

More specifically, since the EL of the SVC shares information based on connection with the lower BL according to the modes I_BL, BL_SKIP, and MV_PRED in conformity with the inter layer prediction, the transform adaptively selects the 4×4 transform and the 8×8 transform. Similar to the BL, the transform is repeated to thus increase the complexity.

The conventional method features good accuracy and performance based on the analysis on the SVC technology and the coding scheme, but has some drawbacks. Since the conventional method selects the best mode through the RDO, it cannot enhance the complexity of the RDO. That is, by merely reducing the number of candidate MB modes, the real-time encoding is not feasible because of the complexity of the RDO.

Since the intra prediction is applied to every candidate mode, MODE_I4×4 performs the intra prediction for nine prediction modes, MODE_I8×8 performs the intra prediction for nine prediction modes, and MODE_I16×16 performs the intra prediction for four prediction modes. Hence, the complexity in the intra prediction is considerable.

The inter prediction needs to perform the RDO with respect to every motion vector in accordance with a Motion Estimation (ME) algorithm in the corresponding range for the candidate MB mode, which raises the complexity.

In addition, since the transform adaptively selects the 4×4 transform and the 8×8 transform, the transform is repeated and the complexity is quite high as in the BL.

### SUMMARY OF THE INVENTION

To address the above-discussed deficiencies of the prior art, it is a primary aspect of the present invention to provide an efficient encoding method for H.264 SVC for enhancing complexity in H.264 SVC encoding process.

Another aspect of the present invention is to provide a fast MB mode decision method for addressing drawbacks of a mode decision method using a conventional RDO in H.264 SVC encoding process, and an adaptive transform selecting method.

According to one aspect of the present invention, a method for determining a macroblock mode of an enhancement layer using macroblock mode MODE_{BL} of a base layer in a H.264 Scalable Video Coding (SVC) encoding process, when the MODE_{BL} is intra, includes when the MODE_{BL} I16×16, performing intra prediction on a Pred_Mode of I16×16 of the MODE_{BL} and calculating a I16×16 mode value; calculating a mode value of an intra base layer I_BL; comparing the I16×16 mode value with the mode value of the intra base layer; and selecting a best mode. When the MODE_{BL} is inter, the method includes calculating a mode value for a skip mode BL_SKIP of the base layer; comparing the mode value for the skip mode of the base layer with a pre-determined Quantization Parameter (QP) threshold; and selecting a best mode.

When the MODE_{BL} is intra, the selecting of the best mode may select the best mode by comparing the I16×16 mode value with the intra base layer I_BL mode value.

When the MODE_{BL} is intra, the method may further include when the MODE_{BL} is I8×8 block or I4×4 block and the intra base layer I_BL mode value is smaller than the QP threshold, selecting the best mode and finishing the mode decision.

When the MODE_{BL} is intra, the method may further include when the intra base layer I_BL mode value is greater than the QP threshold, performing the intra prediction on the Pred_Mode of I4×4 block or I8×8 block of the MODE_{BL} and calculating a mode value of the I4×4 block; and selecting the best mode.

The method may further include when the MODE_{BL} is inter, scalability is CGS, and the mode value for the skip mode is smaller than the QP threshold, selecting the best mode and finishing the mode decision.

Then the MODE_{BL} is MODE 16×16, the method may further include calculating a mode value of the 16×16 block; and when the mode value of the 16×16 block is smaller than the QP threshold, selecting the best mode and finishing the mode decision.

When the MODE_{BL} is MODE 16×8, the method may further include calculating a mode value of the 16×8 block; and when the mode value of the 16×8 block is smaller than the QP threshold, selecting the best mode and finishing the mode decision.

The method may further include when the mode value of the 16×8 block is greater than the QP threshold and the MODE_{BL} is MODE 16×16, calculating a mode value of a 8×16 block; and when the mode value of the 8×16 block is smaller than the QP threshold, selecting the best mode and finishing the mode decision.

When the MODE_{BL} is not MODE 16×16, the method may further include calculating a mode value of the 8×8 block; and when the mode value of the 8×8 block is smaller than the QP threshold, selecting the best mode and finishing the mode decision.

When the MODE_{BL} is MODE 8×16, the method may further include calculating a mode value of the 8×16 block; and when the mode value of the 8×16 block is smaller than the QP threshold, selecting the best mode and finishing the mode decision.

When the MODE_{BL} is MODE 8×8, the method may further include calculating the 8×8 mode value; and when the 8×8 mode value is smaller than the QP threshold, selecting the best mode and finishing the mode decision.

When the MODE_{BL} is not MODE 8×8, the method may further include calculating a mode value of a 8×4 block, a mode value of a 4×8 block, and a mode value of a 4×4 block; and selecting the best mode and finishing the mode decision.

When the mode value of the 8×8 block is greater than the QP threshold and the MODE_{BL} is MODE 8×8, the method may further include calculating a mode value of a 8×4 block, a mode value of a 4×8 block, and a mode value of a 4×4 block; and selecting the best mode and finishing the mode decision.

When the MODE_{BL} is inter and the scalability is not the CGS, the method may further include, when the mode value for the skip mode is smaller than the QP threshold, selecting the best mode and finishing the mode decision.

When the mode value for the skip mode is greater than the predetermined QP threshold, the method may further include when the MODE_{BL} is MODE_{—}16×16, calculating a 16×16× mode value; and when the 16×16 mode value is smaller than the predetermined QP threshold, selecting the best mode.

When the 16×16 mode value is greater than the predetermined QP threshold, the method may further include when a macroblock MODE_{neighbor} around the enhancement layer is MODE_{—}16×8, calculating a 16×8 mode value; when the MODE_{BL} is MODE_{—}16×8, calculating a mode value of the 16×8 block; and when the mode value of the 16×8 block is smaller than the QP threshold, selecting the best mode.

The method may further include when the macroblock MODE_{neighbor} around the enhancement layer is MODE_{—}8×16, calculating a mode value of a 8×16 block; when the MODE_{BL} is MODE_{—}8×16, calculating a mode value of the 8×16 block; and when the mode value of the 8×16 block is smaller than the QP threshold, selecting the best mode.

When the macroblock MODE_{neighbor} around the enhancement layer is not MODE_{—}8×8 or when the MODE_{BL} is not MODE_{—}8×8, the method may further include calculating a mode value of a 8×4 block, a mode value of a 4×8 block, and a mode value of a 4×4 block; and selecting the best mode.

According to another aspect of the present invention, a method for adaptively selecting a transform based on information of a base layer in a H.264 SVC encoding process, when a macroblock mode MODE_{BL} of the base layer is intra and an intra base layer I_BL, includes when the transform of the base layer is 4×4 transform and a DCT coefficient quantized in the base layer is zero, selecting 8×8 transform; when the transform of the base layer is the 4×4 transform and only the quantized DCT coefficient exists in the base layer, selecting the 8×8 transform; when the transform of the base layer is the 8×8 transform, selecting the 8×8 transform; when the transform of the base layer is not the 8×8 transform, selecting the 4×4 transform; and selecting a best mode.

When the MODE_{BL} is inter and scalability is CGS, the method may further include when the transform of the base layer is 4×4 transform and the DCT coefficient quantized in the base layer is zero, selecting 8×8 transform; when the transform of the base layer is the 4×4 transform and only the quantized DCT coefficient exists in the base layer, selecting the 8×8 transform; when the transform of the base layer is the 8×8 transform, selecting the 8×8 transform; when the transform of the base layer is not the 8×8 transform, selecting the 4×4 transform; and selecting the best mode.

When the MODE_{BL} is inter and the scalability is spatial scalability, the method may further include when the transform of the base layer is 4×4 transform and the DCT coefficient quantized in the base layer is zero, selecting 8×8 transform; when the transform of the base layer is the 8×8 transform, selecting the 8×8 transform; when the transform of the base layer is not the 8×8 transform, selecting the 4×4 transform; and selecting the best mode.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a simplified diagram of a conventional mode decision process using Rate-Distortion Optimization (RDO);

FIGS. 2A, 2B and 2C are flowcharts of an efficient mode decision method for H.264 SVC according to an exemplary embodiment of the present invention; and

FIGS. 3A and 3B are flowcharts of an adaptive transform selecting method according to another exemplary embodiment of the present invention.

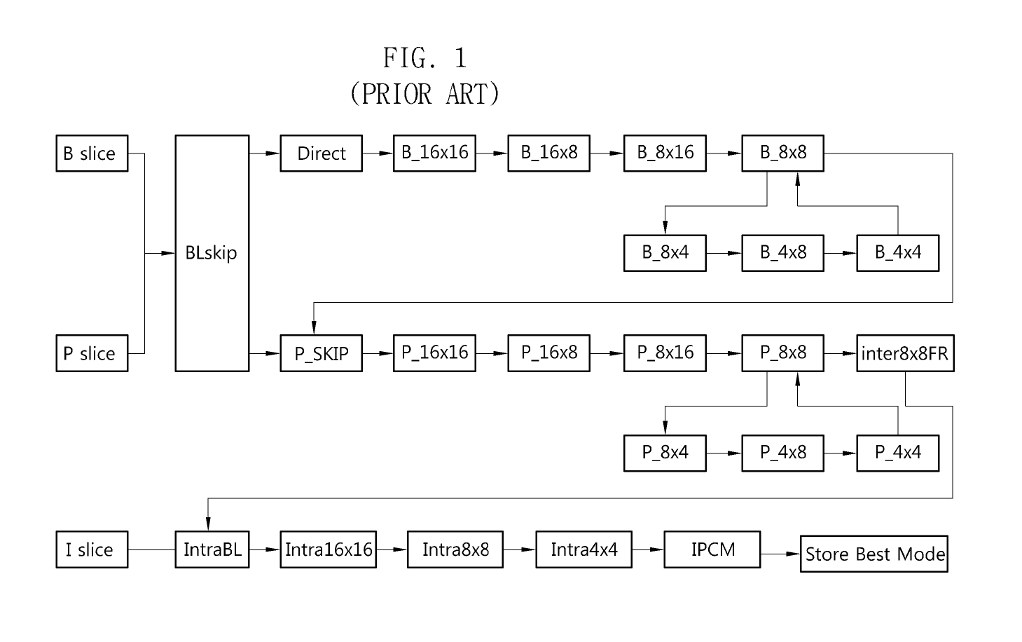

Throughout the drawings, like reference numerals will be understood to refer to like parts, components and structures.

### DETAILED DESCRIPTION OF THE INVENTION

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Exemplary embodiments of the present invention provide refinement of conventional mode decision method and transform selection method in an SVC video encoding process for real-time encoding and complexity improvement in accordance with various applications. That is, the conventional method performs the RDO on a motion vector in the inter prediction or on each prediction mode in the intra prediction with respect to candidate MB modes, and thus maintains high complexity. By contrast, the present invention employs a semi-RDO, rather than the RDO, to select the mode.

That is, the mode is selected using Sum of Absolute Difference (SAD) which is sum of absolute values of a differential value of an original image and a compensated image (the compensated image obtained from a reference image without DCT, quantization, inverse quantization, and IDCT), and bit rate generation values according to a Quantization Parameter (QP) size for a predefined Motion Vector (MV) and a reference index ref idex, as expressed in Equation 1 and Equation 2.

J(mod e_{int er})=SAD(int er,QP)+Rₘᵥ(mvdₓ,mvd_{y},QP)+R_{ref}(Ridₓ,QP) (1)

Rₘᵤ(mvdₓ,mvd_{y},QP)=W(QP)×Genbitₘᵥ(mvdₓ,mvd_{y}) (2)

R_{ref}(Ridx,QP)=W(QP)×Genbitₘᵥ(Ridx) (3)

In Equations 1, 2 and 3, J, which denotes a mode value, is an item compared with a predetermined QP threshold. J(mod e_{int er}) denotes the mode value in the inter mode. SAD denotes the sum of the absolute values of the differential value of the original image and the compensated image, Rₘᵥ denotes bits required to encode the motion vector, and R_{ref} denotes bits required to encode the reference image. W(QP) is the term for applying a weight to the QP value.

J(mod e_{int ra})=SAD(int er,QP)+R_{mod e}(pred_{mod e},QP) (4)

R_{mod e}(R_{pred},QP)=W(QP)×Genbit_{mod e}(pred_{mode}) (5)

In Equations 4 and 5, J, which denotes the mode value, is the item compared with the predetermined QP threshold. J(mod e_{int ra}) denotes the mode value in the intra mode. SAD denotes the sum of the absolute values of the differential value of the original image and the compensated image, Rₘᵥ denotes bits required to encode the motion vector, and R_{ref} denotes bits required to encode the reference image. W(QP) is the term for applying the weight to the QP value.

The present invention provides a mode decision method for an SVC Enhancement Layer (EL). The complexity in the EL is higher than a Base Layer (BL).

Since EL images are the same as the BL image or have a scaling ratio for the resolution, they have considerable spatial redundancy. Thus, by use of MB information of the BL, the complexity can be reduced more efficiently.

To decide the MB mode of the EL, the present invention enhances the complexity by reducing the number of candidate MB modes to compare in the EL encoding based on the MB mode of the BL and reducing the number of candidate MB modes and the number of pred modes according to directivity when the MB mode of the BL is intra, rather than carrying out all of the modes.

A fast algorithm for deciding the MB mode of the EL in the H.264/AVC SVC encoding process is derived through the following analyses.

1. When the corresponding MB mode (hereafter, referred to as MODE_{BL}) of the BL is the intra MB, the MB of the EL is determined mostly to INTRA MB (probability of 95%).

2. In Coarse Granular Scalability (CGS) scalability, the QP size of the EL is smaller than the BS. Thus, the MB modes of the EL increase more fine-partitioned MB modes than the MB modes of the BL. Mostly, the partition type of the MB mode of the BL has a square tree structure. That is, when the MB of the BL is Mode 16×8, the MB mode of the EL is mainly 1×8 or 8×8 mode. This implies that there is no need to predict because the probability of selecting the 8×16 mode drops.

3. In the spatial scalability, it is efficient to obtain information from the MB mode of the MB around the EL (hereafter, referred to as MODEₙₑₜ) as well as the MB mode of the BL.

4. In the temporal scalability, it is also efficient to obtain information from the MB mode of the MB around the EL (hereafter, referred to as MODEₙₑₜ) as well as the MB mode of the BL.

Meanwhile, when the MB of the BL is the intra MB, the following method is used to reduce the number of the Pred_Mode predictions.

1. When the MB of the BL is I_{—}16×16, the prediction is performed only for I_{—}16×16 Pred Mode of the BL MB.

2. When the BL MB is I_{—}4×4 or I_{—}8×8, the prediction is conducted only in two directions around similar to I_{—}4×4 Pred Mode of the BL MB. For example, when the BL MB is I_{—}4×4 and the I_{—}4×4 Pred_Mode is a vertical mode, only a vertical mode, a vertical right mode, and a vertical left mode are predicted to predict I_{—}4×4 of the EL.

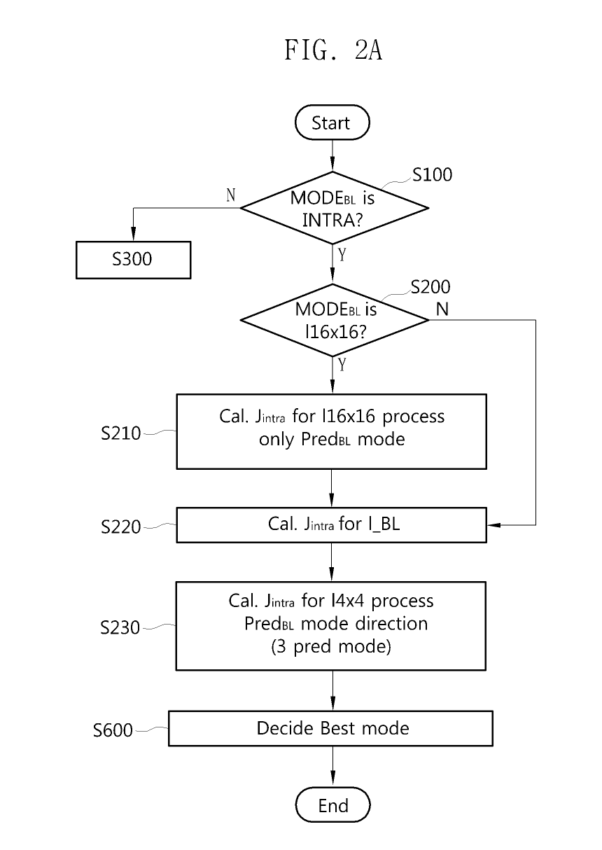

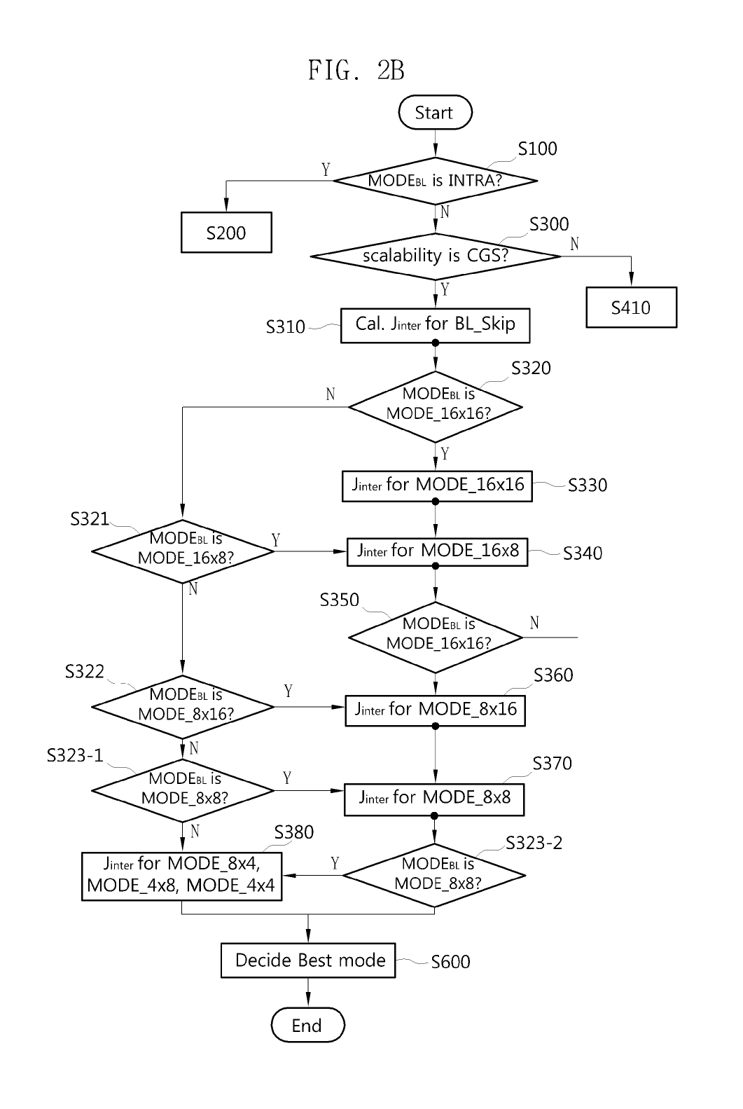

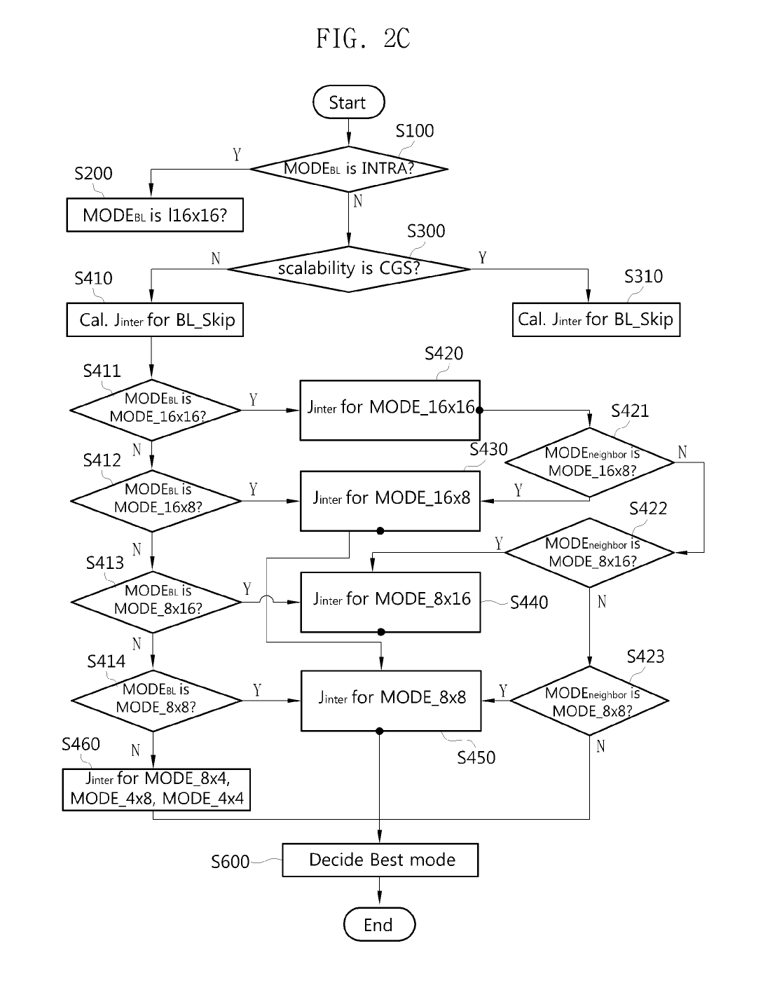

FIG. 2A is a flowchart of an efficient mode decision method for the H.264 SVC according to an exemplary embodiment of the present invention.

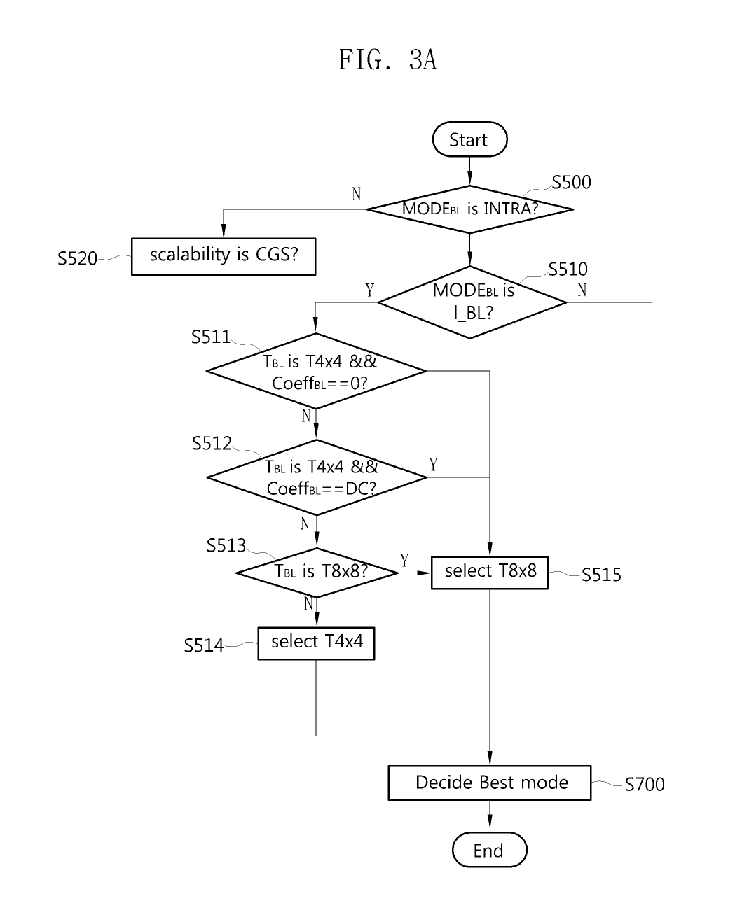

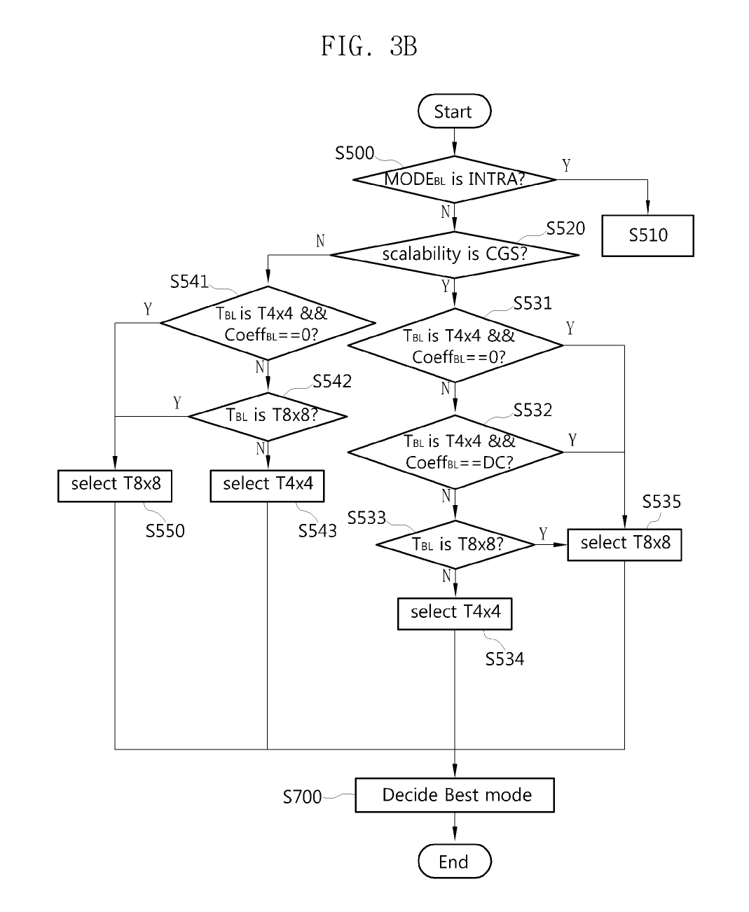

The EL mode decision according to the mode decision method of FIG. 3A refers to information of the MB mode of the BL. Accordingly, the mode decision method can differ depending on the intra MODE_{BL} and the inter MODE_{BL}.

The method determines MODE_{BL} (the corresponding MB mode of the BL) (S100) and considers first the case where MODE_{BL} is intra (S100:Y) and MODE_{BL} is I_{—}16×16. When MODE_{BL} is I_{—}16×16 (S200:Y), the method performs the intra prediction on I16×16_Pred_Mode of MODE_{BL} and then calculates the mode value J_{Intra}(I_{—}16×16) (hereafter J(X) denotes the mode value of the mode X) based on Equations 1 and 2 (S210).

Meanwhile, to decide the mode by comparing J_{Intra}(I_{—}16×16) with J_{Intra}(I_BL), J_{Intra}(I_BL) is calculated (S220). By comparing J_{Intra}(I_{—}16×16) and J_{Intra}(I_BL), the mode of the smaller value is selected as the EL mode and the mode decision process can be finished.

However, when MODE_{BL} is not I_{—}16×16, the calculated J_{Infra}(I_BL) is compared with Thres(QP). The Thres(QP) can be predefined and provided in a table form, and can vary according to the input mode.

When J_{Intra}(I_BL) is smaller than Thres(QP), J_{Intra}(I_BL) can be selected as the best mode.

When J_{Infra}(I_BL) is greater than Thres(QP), the method performs the intre prediction in two nearby direction similar to I_{—}4×4 Pred_Mode when the BL MB is I_{—}4×4 or I_{—}8×8, and calculates J_{Intra}(I_{—}4×4) (S230). For example, when the BL MB is I_{—}4×4 and I_{—}4×4 Pred_Mode is the vertical mode, the I_{—}4×4 prediction of the EL can be performed only for the vertical mode, the vertical right mode, and the vertical left mode. The calculated J_{Intra}(I_{—}4×4) can be selected as the best mode.

Hence, when MODE_{BL} is the intra MB, the number of the predictions of Pred_Mode can be reduced to thus enhance the complexity in the H.264 SVC encoding process.

FIG. 2B is a flowchart of an efficient mode decision method for the H.264 SVC according to another exemplary embodiment of the present invention. The mode decision method can be classified based on whether the scalability is the CGS or not (the spatial capability and the temporal scalability).

FIG. 2B is the flowchart of the mode decision method when MODE_{BL} is inter and the scalability is the CGS.

When MODE_{BL} is inter, the method calculates J_{Inter}(BL_SKIP), which is the skip mode value of the BL, for the BL_SKIP according to the macroblock type MB_TYPE of MODE_{BL}, the motion vector, and the reference index ref_idx regardless of the type of the scalability (S310). When the calculated J_{Inter}(BL_SKIP) is smaller than Thres(QP), the BL_SKIP mode is determined to the mode of the EL (S600) and the mode decision method can be finished (apply the early termination scheme).

When the calculated J_{Inter}(BL_SKIP) is greater than the certain Thres(QP) and MODE_{BL} is MODE_{—}16×16 (S320:Y), the method calculates J_{Inter}(MODE_{—}16×16) (S330). When the calculated J_{Inter}(MODE_{—}16×16) is smaller than the certain Thres(QP), the best mode is determined (S600) and the mode decision process can be finished.

When MODE_{BL} is MODE_{—}16×8 (S321:Y), the method calculates J_{Inter}(MODE_{—}16×8) (S340). When the calculated J_{Inter}(MODE_{—}16×8) is smaller than the certain Thres(QP), the best mode is determined (S600) and the mode decision process can be finished.

When MODE_{BL} is MODE_{—}8×16 (S322:Y), the method calculates J_{Inter}(MODE_{—}8×16) (S360). When the calculated J_{Inter}(MODE_{—}8×16) is smaller than the certain Thres(QP), the best mode is determined (S600) and the mode decision process can be finished. When MODE_{BL} is not MODE_{—}8×16 (S322:N), the method determines whether MODE_{BL} is MODE_{—}8×8 (S323). When MODE_{BL} is MODE_{—}8×8 (S323_1:Y), the method calculates J_{Inter}(MODE_{—}8×8) (S370). When the calculated J_{Inter}(MODE_{—}8×8) is smaller than the certain Thres(QP), the best mode is determined (S600) and the mode decision process can be finished. When the calculated J_{Inter}(MODE_{—}8×8) is not smaller than the certain Thres(QP), the best mode is decided by calculating J_{Inter}(MODE_{—}8×4) J_{Inter}(MODE_{—}4×8), and J_{Inter}(MODE_{—}4×4) respectively (S600).

When MODE_{BL} is MODE_{—}16×16 (S350:Y), the method calculates J_{Inter}(MODE_{—}8×16) (S360). When the calculated J_{Inter}(MODE_{—}8×16) is smaller than the certain Thres(QP), the best mode is determined (S600) and the mode decision process can be finished. When MODE_{BL} is not MODE_{—}16×16 (S350:N), the method calculates J_{Inter}(MODE_{—}8×8) (S370). When the calculated J_{Inter}(MODE_{—}8×8) is smaller than the certain Thres(QP), the best mode is determined (S600) and the mode decision process can be finished. When the calculated J_{Inter}(MODE_{—}8×8) is not smaller than the certain Thres(QP), the best mode is decided by calculating J_{Inter}(MODE_{—}8×4), J_{Inter}(MODE_{—}4×8), and J_{Inter}(MODE_{—}4×4) respectively (S600).

When MODE_{BL} is MODE 8×8 (S323_2:Y), the method decides the best mode by calculating J_{Inter}(MODE_{—}8×4), J_{Inter}(MODE_{—}4×8), and J_{Inter}(MODE_{—}4×4) (S600) and finishes the mode decision. When MODE_{BL} is MODE_{—}8×8 (S323_2:N), the method decides the best mode (S600) and finishes the mode decision.

FIG. 2C is the flowchart of the mode decision method when MODE_{BL} is inter and the scalability is not the CGS; that is, the scalability is the spatial scalability or the temporal scalability.

Referring to FIG. 3C, when MODE_{BL} is inter, the method calculates J_{Inter}(BL_SKIP), which is the skip mode value of the BL, for the BL_SKIP according to the macroblock type MB_TYPE of MODE_{BL}, the motion vector, and the reference index ref_idx regardless of the type of the scalability (S410). When the calculated J_{Inter}(BL_SKIP) is smaller than Thres(QP), the BL_SKIP mode is determined to the mode of the EL (S600) and the mode decision method can be finished (apply the early termination scheme).

When the calculated J_{Inter}(BL_SKIP) is greater than the Thres(QP) and MODE_{BL} is MODE_{—}16×16 (S411:Y), the method calculates J_{Inter}(MODE_{—}16×16) (S420). When the calculated J_{Inter}(MODE_{—}16×16) is smaller than the certain Thres(QP), the best mode is determined (S600) and the mode decision process can be finished.

When J_{Inter}(MODE_{—}16×16) is not smaller than the Thres(QP) and the neighbor MB MODE_{neighbor} of the EL is MODE_{—}16×8 (S421:Y), the method calculates J_{Inter}(MODE_{—}16×8). When the calculated J_{Inter}(MODE_{—}16×8) is smaller than the certain Thres(QP), the method can perform the best mode decision (S600) and finish the mode decision process.

When MODE_{BL} is MODE_{—}16×8 (S412:Y), the method calculates I_{Inter}(MODE_{—}16×8). When the calculated J_{Inter}(MODE_{—}16×8) is smaller than the certain Thres(QP), the best mode is determined (S600) and the mode decision process can be finished.

When J_{Inter}(MODE_{—}16×8) is not smaller than the certain Thres(QP) in the two cases; that is, when MODE_{neighbor} and MODE_{BL} are MODE_{—}16×8, the process when MODE_{BL} is MODE_{—}8×8, to be explained, is conducted.

When the neighbor MB MODE_{neighbor} of the EL is MODE_{—}8×16 (S422:Y), the method calculates J_{Inter}(MODE_{—}8×16). When the calculated J_{Inter}(MODE_{—}8×16) is smaller than the certain Thres(QP), the best mode is determined (S600) and the mode decision process can be finished.

When MODE_{BL} is MODE_{—}8×16 (S413:Y), the method calculates J_{Inter}(MODE_{—}8×16). When the calculated J_{Inter}(MODE_{—}8×16) is smaller than the certain Thres(QP), the best mode is determined (S600) and the mode decision process can be finished.

When J_{Inter}(MODE_{—}8×16) is not smaller than the certain Thres(QP) in the two cases; that is, when MODE_{neighbor} and MODE_{BL} are MODE_{—}8×16, the method calculates J_{Inter}(MODE_{—}8×8) and then performs the best mode decision process.

When the neighbor MB MODE_{neighbor} of the EL is MODE_{—}8×8 (S423:Y), the method calculates J_{Inter}(MODE_{—}8×8) and performs the best mode decision (S600). When the neighbor MB MODE_{neighbor} of the EL is not MODE_{—}8×8 (S423:N), the method performs the best mode decision (S600).

When MODE_{BL} is MODE_{—}8×8 (S414:Y), the method calculates J_{Inter}(MODE_{—}8×8) and performs the best mode decision (S600). When the neighbor MB MODE_{BL} of the EL is not MODE_{—}8×8 (S423:N), the method calculates J_{Inter}(MODE_{—}8×4), J_{Inter}(MODE_{—}4×8), and J_{Inter}(MODE_{—}4×4), and performs the best mode decision (S600).

Meanwhile, the transform adopted in the H.264/AVC can selectively utilize the 4×4 DCT transform and the 8×8 DCT transform. In general, the transform selection carries out the two transform schemes and then selects the better result.

However, since the EL encoding in the H.264/AVC SVC has the information of the pre-encoded BL, it is possible to encode more efficiently than the all of transform schemes are conducted and the better one is selected. Accordingly, the present invention provides a method for adaptively selecting the transform based on the BL information.

The method for adaptively selecting the transform is derived through the following analyses.

1. The encoding efficiency rises because the number of the bits after the entropy encoding is small as the quantized DCT coefficients which are the data after the transform and the quantization are small.

2. When the quantized DCT coefficients after the 4×4 transform in four 4×4 blocks of the 8×8 block unit are all zero, it is highly likely that all of the DCT coefficients quantized after the 8×8 transform of the 8×8 block is zero. In this case, it is advantageous to use the 8×8 transform in terms of the bit efficiency.

3. When the DCT coefficients quantized after the 4×4 transform in four 4×4 blocks of the 8×8 block unit have only the DC value, it is highly likely that the DCT coefficients quantized after the 8×8 transform of the 8×8 block have only the DC value as well.

FIGS. 3A and 3B illustrate of an adaptive transform selecting method according to exemplary embodiments of the present invention.

FIG. 3A is a flowchart of the adaptive transform selecting method according to yet another exemplary embodiments of the present invention.

First, the case where the corresponding macroblock mode MODE_{BL} of the BL is intra is explained. The transform selection of the BL can employ the conventional transform selecting method.

When MODE_{BL} is intra, MODE_{CUR} which is the EL mode to currently transform is I_BL, the transform T_{BL} of the BL is 4×4 transform (hereafter, referred to as T4×4), and the quantized Discrete Cosine Transform (DCT) coefficient (hereafter, referred to as Coeff_{BL}) in the BL is zero, T8×8 is selected (S515) and the best transform scheme is selected (S700).

When T_{BL} is T4×4 and Coeff_{BL} has only DC (S512), T8×8 is selected (S515) and the best transform scheme is selected (S700).

When T_{BL} is T8×8 (S515), T8×8 is selected (S512). Otherwise, T8×8 is selected (S514) and the best transform scheme is selected (S700).

FIG. 3B is a flowchart of the adaptive transform selecting method according to yet another exemplary embodiments of the present invention.

When MODE_{BL} is inter, the transform scheme can be selected according to the type of the scalability as described in FIGS. 2B and 2C.

First, the case where the scalability is the CGS is illustrated.

When T_{BL,} is T4×4 and Coeff_{BL} has only DC (S512), T8×8 is selected (S515) and the best transform is scheme selected (S700).

When MODE_{CUR} which is the EL mode to currently transform is I_BL, the transform T_{BL} of the BL is 4×4 transform (hereafter, referred to as T4×4), and the quantized DCT coefficient (hereafter, referred to as Coeff_{BL}) in the BL is 0, T8×8 is selected (S515) and the best transform scheme is selected (S700).

When T_{BL} is T4×4 and Coeff_{BL} is zero (S531), T8×8 is selected (S535) and the best transform scheme is selected (S700).

When T_{BL} is T4×4 and Coeff_{BL} has only DC (S532), T8×8 is selected (S535) and the best transform scheme is selected (S700).

When T_{BL} is T4×8 (S515), T8×8 is selected (S512). Otherwise, T8×8 is selected (S514) and the best transform scheme is selected (S700).

Meanwhile, when the scalability is the spatial scalability, T_{BL} is T4×4, and Coeff_{BL} is zero (S542), T8×8 is selected and then the best transform scheme is selected (S700).

When T_{BL} is T8×8, T8×8 is selected and then the best transform scheme is selected (S700). Otherwise, T4×4 is selected (S514) and the best transform scheme is selected (S700).

Primarily, the fast mode decision method for the H.264 SVC and the transform selection method of the present invention can be easily applicable to the H.264/AVC SVC. Fundamentally, the present methods are applicable to the layer based video encoding scheme such as H.264/AVC SVC. That is, to generate the bit stream having the resolution or image quality difference with respect to the same image and to determine the MB mode, the pre-encoded information (the lower layer information and the neighbor MB information) can be used. Also, it is possible to adaptively select the transform in the encoding scheme adopting various transforms.

In the light of the foregoing, compared to the mode decision method using the conventional RDO scheme, the present invention can greatly enhance the complexity of the mode decision.

In the H.264/AVC SVC with much higher complexity than the conventional codec, the MB mode decision method occupying most of the complexity determines the mode value for a particular mode based on the reference, rather than the optimized RDO, and finishes the mode decision upon determining that the determined mode value is smaller than the quantization threshold. Therefore, the fast MB mode decision method drastically reduces the complexity in the encoding process.

In addition, the complexity can be further reduced by adaptively selecting the transform which occupies the complexity, compared to the coding efficiency.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for determining a macroblock mode of an enhancement layer using macroblock mode MODE_{BL} of a base layer in a H.264 Scalable Video Coding (SVC) encoding process, the method comprising, when the MODE_{BL} is intra:
when the MODE_{BL} I16×16, performing intra prediction on a Pred_Mode of I16×16 of the MODE_{BL} and calculating a I16×16 mode value;
calculating a mode value of an intra base layer I_BL;
comparing the I16×16 mode value with the mode value of the intra base layer; and
selecting a best mode, and
when the MODE_{BL} is inter:
calculating a mode value for a skip mode BL_SKIP of the base layer;
comparing the mode value for the skip mode of the base layer with a pre-determined Quantization Parameter (QP) threshold; and
selecting a best mode.

2. The method of claim 1, wherein, when the MODE_{BL} is intra, the selecting of the best mode selects the best mode by comparing the I16×16 mode value with the intra base layer I_BL mode value.

3. The method of claim 1, further comprising, when the MODE_{BL} is intra:
when the MODE_{BL} is I8×8 block or I4×4 block and the intra base layer I_BL mode value is smaller than the QP threshold, selecting the best mode and finishing the mode decision.

4. The method of claim 3, further comprising, when the MODE_{BL} is intra:
when the intra base layer I_BL mode value is greater than the QP threshold, performing the intra prediction on the Pred_Mode of I4×4 block or I8×8 block of the MODE_{BL} and calculating a mode value of the I4×4 block; and
selecting the best mode.

5. The method of claim 1, further comprising:
when the MODE_{BL} is inter, scalability is CGS, and the mode value for the skip mode is smaller than the QP threshold, selecting the best mode and finishing the mode decision.

6. The method of claim 5, further comprising, when the MODE_{BL} is MODE 16×16:
calculating a mode value of the 16×16 block; and
when the mode value of the 16×16 block is smaller than the QP threshold, selecting the best mode and finishing the mode decision.

7. The method of claim 6, further comprising, when the MODE_{BL} is MODE 16×8:
calculating a mode value of the 16×8 block; and
when the mode value of the 16×8 block is smaller than the QP threshold, selecting the best mode and finishing the mode decision.

8. The method of claim 7, further comprising:
when the mode value of the 16×8 block is greater than the QP threshold and the MODE_{BL} is MODE 16×16, calculating a mode value of a 8×16 block; and
when the mode value of the 8×16 block is smaller than the QP threshold, selecting the best mode and finishing the mode decision.

9. The method of claim 8, further comprising, when the MODE_{BL} is not MODE 16×16:
calculating a mode value of the 8×8 block; and
when the mode value of the 8×8 block is smaller than the QP threshold, selecting the best mode and finishing the mode decision.

10. The method of claim 7, further comprising, when the MODE_{BL} is MODE 8×16:
calculating a mode value of the 8×16 block; and
when the mode value of the 8×16 block is smaller than the QP threshold, selecting the best mode and finishing the mode decision.

11. The method of claim 10, further comprising, when the MODE_{BL} is MODE 8×8:
calculating the 8×8 mode value; and
when the 8×8 mode value is smaller than the QP threshold, selecting the best mode and finishing the mode decision.

12. The method of claim 10, further comprising, when the MODE_{BL} is not MODE 8×8:
calculating a mode value of a 8×4 block, a mode value of a 4×8 block, and a mode value of a 4×4 block; and
selecting the best mode and finishing the mode decision.

13. The method of claim 11, further comprising, when the mode value of the 8×8 block is greater than the QP threshold and the MODE_{BL} is MODE 8×8:
calculating a mode value of a 8×4 block, a mode value of a 4×8 block, and a mode value of a 4×4 block; and
selecting the best mode and finishing the mode decision.

14. The method of claim 1, further comprising, when the MODE_{BL} is inter and the scalability is not the CGS:
when the mode value for the skip mode is smaller than the QP threshold, selecting the best mode and finishing the mode decision.

15. The method of claim 14, further comprising, when the mode value for the skip mode is greater than the predetermined QP threshold:
when the MODE_{BL} is MODE_{—}16×16, calculating a 16×16× mode value; and
when the 16×16 mode value is smaller than the predetermined QP threshold, selecting the best mode.

16. The method of claim 15, further comprising, when the 16×16 mode value is greater than the predetermined QP threshold:
when a macroblock MODE_{neighbor} around the enhancement layer is MODE 16×8, calculating a 16×8 mode value;
when the MODE_{BL} is MODE_{—}16×8, calculating a mode value of the 16×8 block; and
when the mode value of the 16×8 block is smaller than the QP threshold, selecting the best mode.

17. The method of claim 16, further comprising:
when the macroblock MODE_{neighbor} around the enhancement layer is MODE_{—}8×16, calculating a mode value of a 8×16 block;
when the MODE_{BL} is MODE_{—}8×16, calculating a mode value of the 8×16 block; and
when the mode value of the 8×16 block is smaller than the QP threshold, selecting the best mode.

18. The method of claim 17, further comprising, when the macroblock MODE_{neighbor} around the enhancement layer is not MODE_{—}8×8 or when the MODE_{BL} is not MODE 8×8:
calculating a mode value of a 8×4 block, a mode value of a 4×8 block, and a mode value of a 4×4 block; and
selecting the best mode.

19. A method for adaptively selecting a transform based on information of a base layer in a H.264 SVC encoding process, the method comprising, when a macroblock mode MODE_{BL} of the base layer is intra and an intra base layer I_BL:
when the transform of the base layer is 4×4 transform and a DCT coefficient quantized in the base layer is zero, selecting 8×8 transform;
when the transform of the base layer is the 4×4 transform and only the quantized DCT coefficient exists in the base layer, selecting the 8×8 transform;
when the transform of the base layer is the 8×8 transform, selecting the 8×8 transform;
when the transform of the base layer is not the 8×8 transform, selecting the 4×4 transform; and
selecting a best mode.

20. The method of claim 19, further comprising, when the MODE_{BL} is inter and scalability is CGS:
when the transform of the base layer is 4×4 transform and the DCT coefficient quantized in the base layer is zero, selecting 8×8 transform;
when the transform of the base layer is the 4×4 transform and only the quantized DCT coefficient exists in the base layer, selecting the 8×8 transform;
when the transform of the base layer is the 8×8 transform, selecting the 8×8 transform;
when the transform of the base layer is not the 8×8 transform, selecting the 4×4 transform; and
selecting the best mode.

21. The method of claim 19, further comprising, when the MODE_{BL} is inter and the scalability is spatial scalability:
when the transform of the base layer is 4×4 transform and the DCT coefficient quantized in the base layer is zero, selecting 8×8 transform;
when the transform of the base layer is the 8×8 transform, selecting the 8×8 transform;
when the transform of the base layer is not the 8×8 transform, selecting the 4×4 transform; and
selecting the best mode.
